(19) United States
(12) Patent Application Publication
(10) Pub. No.: US 2026/0285242 A1
(43) Pub. Date: Sep. 24, 2026

(54) COMPOSITE ARTICLES INCLUDING FUNCTIONAL FILMS

(71) Applicant: HANWHA AZDEL, INC., Forest, VA (US)

(72) Inventors: Richard Hahnkee Kim, Forest, VA (US); Ruomiao Wang, Forest, VA (US); Mark Fero, Forest, VA (US); Peter T Evers, JR., Forest, VA (US)

(21) Appl. No.: 19/347,292

(22) Filed: Oct. 1, 2025

Related U.S. Application Data
(60) Provisional application No. 63/701,727, filed on Oct. 1, 2024.
(60) Provisional application No. 63/741,342, filed on Jan. 2, 2025.

(51) Int. Cl. B60R 13/02; B32B 3/12; B32B 27/10; B32B 27/32; B32B 27/34; B60R 13/01

(52) U.S. Cl. CPC B60R 13/0212; B32B 3/12; B32B 27/10; B32B 27/32; B32B 27/34; B60R 13/01; B32B 2262/101; B32B 2305/024; B32B 2305/026; B32B 2307/718; B32B 2605/003

(57) ABSTRACT

Certain configurations of composite articles including a functional film layer are described. The functional film layer can be used to bond a skin layer to an underlying core layer to prevent delamination of the skin layer from the core layer. The core layer can be a cellulose based material or can be a non-cellulose based material. The composite articles can be used in vehicle load floors and vehicle headliners that can resist delamination over wider temperature ranges and/or more extreme environmental conditions than existing articles.

### PRIORITY APPLICATIONS

This application is related to, and claims priority to and the benefit of, each of U.S. Application No. 63/701,727 filed on Oct. 1, 2024 and U.S. Application No. 63/741,342 filed on Jan. 2, 2025, the entire disclosure of each of which is hereby incorporated herein by reference for all purposes.

### TECHNOLOGICAL FIELD

Certain configurations are described of functional adhesive films that can be used in reinforced thermoplastic composite articles. Methods of producing the composite articles in an automated manner are also provided.

### BACKGROUND

Articles for automotive and construction materials applications typically are designed to meet a number of competing and stringent performance specifications. In many instances, the operating conditions of the articles may be limited based on the presence of certain materials. The articles may fail or otherwise become inoperable if exposed to environmental conditions outside of certain ranges.

### SUMMARY

Certain aspects related to articles including functional adhesive films that can be applied in an inline manner are described. More particularly, certain configurations of functional adhesive films which can be used in reinforced thermoplastic composite articles that can retain their physical properties over wider environmental conditions are described.

In an aspect, a composite article comprises a core layer, a first skin and a first functional film disposed on a first surface of the core layer and between the core layer and the first skin. In some embodiments, the first functional film is effective to bond the first skin to the core layer after environmental cycling of the composite article over a temperature range of −40 degrees Celsius to +85 degrees Celsius without delamination of the first skin from the core layer.

In certain embodiments, the first skin comprises a first porous layer comprising a web of open celled structures formed from reinforcing materials held in place by a thermoplastic material. In other embodiments, the first functional film comprises at least two film layers. In some embodiments, a first layer of the first functional film comprises a polyolefin layer and a second layer of the first adhesive film comprises a copolyamide layer, wherein the polyolefin layer is adjacent to the core layer and the copolyamide layer is adjacent to the first skin.

In certain embodiments, the first functional film comprises a first polyolefin film layer and a second copolyamide film layer. In some embodiments, the first polyolefin film layer comprises polypropylene. In other embodiments, a basis weight of first functional film is at least 70 g/m².

In certain configurations, the composite article comprises a second skin disposed on a second surface of the core layer. In some embodiments, the composite article comprises a second functional film disposed between the second skin and the second surface of the core layer, wherein the second functional film is effective to bond the second skin to the core layer after environmental cycling of the composite article over a temperature range of −40 degrees Celsius to +85 degrees Celsius without delamination of the second skin from the core layer.

In certain embodiments, the first skin comprises a first porous layer and the second skin comprises a second porous layer disposed on the second functional film, wherein the second porous layer comprises a web of open celled structures formed from reinforcing materials held in place by a thermoplastic material. In some embodiments, the reinforcing materials in each of the first porous layer and the second porous layer comprises glass fibers. In other embodiments, the thermoplastic material in each of the first porous layer and the second porous layer comprises a polyolefin. In certain embodiments, the polyolefin in each of the first porous layer and the second porous layer comprises polypropylene. In additional embodiments, the composite article is configured as vehicle load floor.

In certain embodiments, the core layer comprises a paper honeycomb layer.

In other embodiments, the first functional film comprises: (i) a film comprising a polyamide layer; or (ii) a film comprising a copolyamide layer; or (iii) a film comprising a polyolefin film layer and a copolyamide film layer; or (iv) a film comprising a metallized film layer.

In certain embodiments, the composite article comprises a second skin disposed on a second surface of the core layer and second functional film disposed between the second skin and the second surface of the core layer, wherein the second functional film is effective to bond the second skin to the core layer after environmental cycling of the composite article over a temperature range of −40 degrees Celsius to +85 degrees Celsius without delamination of the second skin from the core layer. In some embodiments, a basis weight of each of the first functional film and the second functional film is at least 70 g/m².

In other embodiments, the first skin comprises a first porous layer and the second skin comprises a second porous layer, wherein each of the first porous layer and the second porous layer comprises a web of open celled structures formed from reinforcing materials held in place by a thermoplastic material.

In another aspect, an automotive vehicle headliner comprises a porous thermoplastic core layer comprising a web formed from reinforcing materials held in place by a thermoplastic material, a first skin, and a first functional film disposed on a first surface of the porous thermoplastic core layer and between the porous thermoplastic core layer and the first skin. In certain embodiments, the first functional film is effective to bond the first skin to the porous thermoplastic core layer after environmental cycling of the composite article over a temperature range of −40 degrees Celsius to +85 degrees Celsius without delamination of the first skin from the porous thermoplastic core layer.

In some embodiments, the first functional film comprises a at least two film layers. In other embodiments, a first layer of the first functional film comprises a polyolefin layer and a second layer of the first functional film comprises a copolyamide layer, wherein the polyolefin layer is adjacent to the porous thermoplastic core layer and the copolyamide layer is adjacent to the first skin. In some embodiments, a basis weight of first functional film is at least 70 g/m².

In additional embodiments, the first functional film comprises a first polyolefin film layer and a second copolyamide film layer and at least one film layer between the first polyolefin film layer and the second copolyamide film layer. In certain embodiments, the first functional film comprises a tie layer between the first polyolefin film layer and the second copolyamide film layer.

In some configurations, the vehicle headliner comprises a second skin disposed on a second surface of the porous thermoplastic core layer. In other embodiments, the vehicle headliner comprises a second functional film disposed between the second skin and the second surface of the porous thermoplastic core layer, wherein the second functional film is effective to bond the second skin to the porous thermoplastic core layer after environmental cycling of the composite article over a temperature range of −40 degrees Celsius to +85 degrees Celsius without delamination of the second skin from the porous thermoplastic core layer. In certain embodiments, the second functional film comprises: (i) a film comprising a polyamide layer; or (ii) a film comprising a copolyamide layer; or (iii) a film comprising a polyolefin film layer and a copolyamide film layer; or (iv) a film comprising a metallized film layer. In certain embodiments, the first functional film comprises at least two film layers. In other embodiments, the reinforcing materials in the porous thermoplastic core layer comprise glass fibers.

In certain embodiments, the thermoplastic material in the porous thermoplastic core layer comprises polypropylene. In other embodiments, the first skin comprises a scrim. In some embodiments, the second skin comprises a scrim. In certain configurations, a fabric layer covers the scrim.

In other embodiments, the first skin comprises a film, and the second skin comprises a scrim. In some configurations, a fabric layer covers the scrim or the film or both.

In certain embodiments, the first skin is a bi-laminate skin, e.g., has only two layers of material.

In another aspect, an-line process of producing a thermoplastic composite article including a functional film using an in-line system comprises combining reinforcing materials and a thermoplastic material in an aqueous solution. The process can also include disposing the aqueous solution with the combined reinforcing materials and the thermoplastic material onto a moving support. The process can also include removing water from the disposed aqueous solution on the moving support to form a web comprising open cell structures formed from the reinforcing materials and the thermoplastic material. The process can also include drying the web on the moving support to provide a porous core layer. The process can also include heating the dried, porous core layer on the moving support to melt the thermoplastic material of the heated, porous core layer. The process can also include disposing a first functional film layer on a first surface of the heated, porous core layer on the moving support. The process can also include disposing a first skin layer on the disposed, first functional film layer. The process can also include applying pressure to the heated, porous core layer comprising the disposed first functional film layer and the disposed first skin layer to provide a thermoplastic composite article.

In certain embodiments, the first functional film layer is disposed from a roll of film material. In other embodiments, the first skin layer is disposed from a roll of first skin layer material. In some embodiments, the process comprises disposing a second skin layer on a second surface of the heated, porous core layer on the moving support. In certain embodiments, the second skin layer is disposed from a roll of second skin layer material.

In another aspect, a n in-line process of producing a composite article including a functional film using an in-line system comprises disposing a first functional film layer on a first surface of a core layer on a moving support, disposing a first skin layer on the disposed, first functional film layer, and applying pressure to the heated, core layer comprising the disposed first functional film layer and the first skin layer to provide a composite article.

In certain embodiments, the first functional film layer is disposed from a roll of film material. In other embodiments, the first skin layer is disposed from a roll of first skin layer material. In some embodiments, the process can include disposing a second skin layer on a second surface of the heated, porous core layer on the moving support. In other embodiments, the second skin layer is disposed from a roll of second skin layer material.

Additional aspects, embodiments, configurations and features are described in more detail below.

### BRIEF DESCRIPTION OF THE SEVERAL VIEWS OF THE DRAWINGS

Certain features of functional films, composite articles including functional films and methods of producing composite articles including functional films are described below with reference to the accompanying drawings in which:

FIG. 1 is an illustration showing a paper honeycomb core coupled to a functional film;

FIG. 2 is an illustration showing a paper honeycomb core coupled to a skin through a functional film;

FIG. 3 is an illustration showing a porous thermoplastic core coupled to a functional film;

FIG. 4 is an illustration showing a porous thermoplastic core coupled to a skin through a functional film;

FIG. 5 is an illustration showing a paper honeycomb core coupled to a functional film on each surface of the paper honeycomb core;

FIG. 6 is an illustration showing a porous thermoplastic core coupled to a functional film on each surface of the porous thermoplastic core;

FIG. 7 is an illustration showing a paper honeycomb core coupled to a skin through a functional film;

FIG. 8 is an illustration showing a porous thermoplastic core coupled to a skin through a functional film;

FIG. 9 is an illustration showing two paper honeycomb cores coupled to each other through a functional film;

FIG. 10 is an illustration showing two porous thermoplastic cores coupled to each other through a functional film;

FIG. 11 is an illustration showing a paper honeycomb core coupled to a porous thermoplastic core through a functional film;

FIG. 12 is an illustration showing a paper honeycomb core coupled to a porous thermoplastic core on each surface of the paper honeycomb core through a functional film;

FIG. 13 is an illustration showing a porous thermoplastic core coupled to a paper honeycomb core on each surface of the porous thermoplastic core through a functional film;

FIG. 14 is an illustration showing a paper honeycomb core coupled to a first skin through a functional film and coupled directly to a second skin;

FIG. 15 is an illustration showing a paper honeycomb core coupled to a first skin through a functional film and coupled to a second skin through a functional film;

FIG. 16 is an illustration showing a porous thermoplastic core coupled to a first skin through a functional film and coupled directly to a second skin;

FIG. 17 is an illustration showing a porous thermoplastic core coupled to a first skin through a functional film and coupled to a second skin through a functional film;

FIG. 18 is an illustration showing a single layer functional film;

FIG. 19 is an illustration showing a bi-layer functional film;

FIG. 20 is an illustration showing a tri-layer functional film;

FIG. 21 is an illustration showing a vehicle floor;

FIG. 22 is an illustration showing a vehicle load floor;

FIG. 23 is an illustration showing an automotive headliner;

FIG. 24 is an illustration showing a process which can be used to produce a composite article including a functional film;

FIG. 25 is an illustration showing reservoirs which can house various materials;

FIG. 26 is an illustration showing depositing of materials onto a wire screen;

FIG. 27 is an illustration showing a wire screen;

FIG. 28 is an illustration showing a web being formed on a wire screen;

FIG. 29 is an illustration showing a porous thermoplastic core being formed on a wire screen;

FIG. 30 is an illustration showing a pressure device used to remove liquid from a web on a wire screen;

FIG. 31 is an illustration showing lamination of a functional film to a surface of a thermoplastic porous core;

FIG. 32 is an illustration showing lamination of a functional film to a first surface of a thermoplastic porous core and lamination of a skin to a second surface of the thermoplastic porous core;

FIG. 33 is an illustration of an in-line system that can be used to produce composite articles including a functional film; and

FIG. 34 is a diagram of a vehicle load floor assembly including different layers.

It will be recognized by the person of ordinary skill in the art, given the benefit of this disclosure, that certain dimensions or features in the figures may have been enlarged, distorted or shown in an otherwise unconventional or non-proportional manner to provide a more user friendly version of the figures. No particular thickness, width or length is intended by the depictions in the figures, and relative sizes of the figure components are not intended to limit the sizes of any of the components in the figures. Where dimensions or values are specified in the description below, the dimensions or values are provided for illustrative purposes only. In addition, no particular material or arrangement is intended to be required by virtue of shading of certain portions of the figures, and even though different components in the figures may include shading for purposes of distinction, the different components can include the same or similar materials, if desired.

### DETAILED DESCRIPTION

Certain embodiments are described below with reference to singular and plural terms in order to provide a more user friendly description of the technology disclosed herein. These terms are used for convenience purposes only and are not intended to limit the layers, assemblies, articles, methods and other subject matter as including or excluding certain features unless otherwise noted as being present in a particular embodiment or excluded from a particular embodiment described herein.

In certain embodiments, the materials described herein can be used together to provide sheets, panels, floor pans, load floors, vehicle floors and other components used in vehicles. For example, a composite article can be produced and used in automotive applications such as, for example, vehicle load floors or vehicle headliners. Where the assembly is used as a vehicle load floor, the load floor may be present as an underbody assembly within the vehicle cabin or may be present as or in one or more different components or areas of the vehicle, e.g., as a drawn load floor in a vehicle storage compartment in the rear of a vehicle. In some instances, the assembly can be used as a vehicle load floor without any supporting structural support from the vehicle, e.g., the load floor may be constructed and arranged to support a load of a selected weight without the need to provide structural support or reinforcement underneath the load floor.

The development of lightweight reinforced thermoplastic (LWRT) composite articles has been driven by the growing demand for lighter materials in industries like aerospace, automotive, and consumer electronics. LWRT combines mechanical properties such as high strength, stiffness, and impact resistance with a low weight profile. Additionally, LWRT composite articles can be corrosion-resistant, thermally stable, and recyclable, positioning them as a sustainable alternative to traditional materials. Certain LWRT articles described herein are suitable for use over a wide temperature range including, for example, from −40 degrees Celsius to +85 degrees Celsius. These LWRT articles can undergo environmental cycling over this temperature range. For example, the LWRT composite article can be lowered from ambient temperature to a temperature of −30 degrees or −40 degrees (depending on the test) and maintained at that temperature for about three hours without humidity control. The temperature can then be increased to an optional intermediate level, e.g., +40 degrees Celsius and 95% relative humidity for about three hours. The temperature can be increased further to a final temperature, e.g., +85 degrees Celsius with controlled or uncontrolled humidity, for about three hours. The temperature can then be allowed to return to ambient to complete the environmental cycle. Total cycle time varies depending on how fast the temperature is changed and whether the optional intermediate temperature step is used and can vary from about six hours to about twelve hours per cycle. By repeatedly altering the temperature and/or humidity conditions, the durability of the LWRT composite articles can be tested to determine if delamination or failure occurs. As discussed in more detail below, the presence of a functional film provides LWRT composite articles that can withstand multiple environmental cycles without delamination of a cover layer from an underlying core layer.

Certain embodiments described herein are directed to LWRT composite articles that include a functional film designed to prevent delamination of an overlying skin layer from an underlying core layer. The functional film can bond two or more other layers of the LWRT composite article to each other over a wide range of environmental conditions and/or permit production of the LWRT composite articles in a more automated manner. For example, in certain instances the functional film can prevent delamination between two layers over a temperature range of −40 degrees Celsius to +85 degrees Celsius. In other instances, the functional film can prevent delamination in high humidity environments, e.g., 95% relative humidity, and may assist in reducing or eliminating penetration of moisture into internal layers of the LWRT composite articles. In other configurations, the functional film can be used to bond bi-laminate surface coverings to a porous thermoplastic core layer without delamination of the bi-laminate surface covering from the porous thermoplastic core layer over a wide temperature range, e.g., −40 degrees Celsius to +85 degrees Celsius. Delamination can be measured by visually observing whether there is any separation of the skin covering from the underlying core. In general, some portion of the skin will peel away from the core and create bubbles or areas where cohesive failure is observed when delamination occurs. The use of less expensive bi-laminate cover materials can reduce cost and overall weight of the LWRT composite article. In some embodiments, the functional film is selected so it can be applied to a core in an automated manner using an inline system that can also apply skins or other layers to the core.

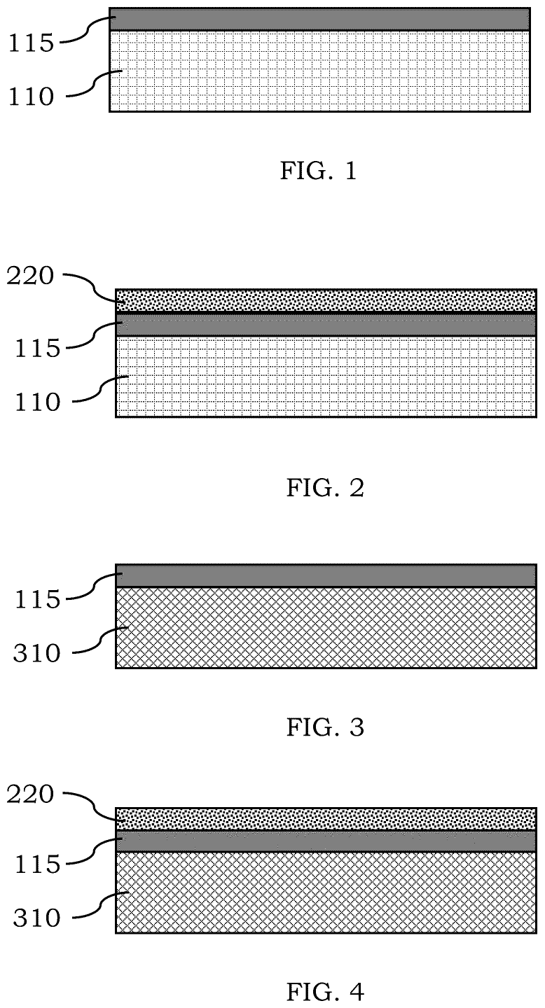

In certain embodiments, the functional films described herein can be used in combination with a core layer. The exact nature of the core layer can vary and in some instances, the core layer comprises cellulose, whereas in other instances the core layer is cellulose free. The core layer can be porous or can be non-porous or have areas of different porosities if desired. In some embodiments, the core layer may comprise a paper honeycomb structure as shown in FIG. 1, where a paper honeycomb core 110 is shown as being bonded to a functional film 115. The paper honeycomb core 110 typically includes some cellular type structure with open space, which can make it difficult for the paper honeycomb core 110 to bond to any covering or skin layers. Referring to FIG. 2, a skin 220 is shown as being bonded to the paper honeycomb core 110 through the functional film 115. The functional film 115 can include suitable materials to prevent delamination of the skin 220 from the core 110 over a wide range of environmental conditions including a wide temperature range, e.g., −40 degrees Celsius to +85 degrees Celsius and/or at high humidity levels including 95% relative humidity. Various materials for the skin 220 are discussed in more detail below, but in some configurations the skin may be a bi-laminate skin or even a single layer skin. The film 115 can be a single layer film, a bi-layer film, a tri-layer film or a film including more than three layers as discussed in more detail below. Further, the film 115 can be a “heavy” film having a basis weight of 75 g/m² or more.

In other embodiments, the core layers described herein can include porous thermoplastic core layers comprising a web of open celled structures formed from reinforcing materials held in place by a thermoplastic material. In some embodiments, a skin layer similar to a porous thermoplastic core layer can be used in combination with other layers. For example, a skin can include a web of open celled structures formed from reinforcing materials held in place by a thermoplastic material. An illustration is shown in FIG. 3, where a porous thermoplastic core layer 310 has a functional film 115 on a first surface. The functional film 115 can be used to bond a skin 220 to the porous thermoplastic core layer 310 as shown in FIG. 4. The functional film 115 can include suitable materials to prevent delamination of the skin 220 from the core 310 over a wide range of environmental conditions including a wide temperature range, e.g., −40 degrees Celsius to +85 degrees Celsius and/or at high humidity levels including 95% relative humidity. Various materials for the skin 220 are discussed in more detail below, but in some configurations the skin may be a bi-laminate skin or even a single layer skin. The film 115 can be a single layer film, a bi-layer film, a tri-layer film or a film including more than three layers as discussed in more detail below. Further, the film 115 can be a “heavy” film having a basis weight of 75 g/m² more.

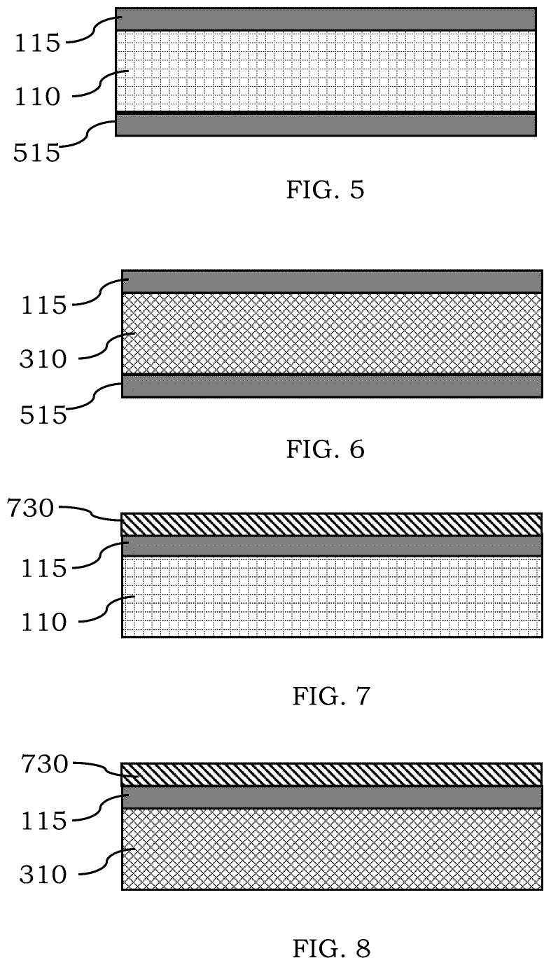

In certain embodiments, a functional film can be present on each side of a core layer as shown in FIG. 5 and FIG. 6. The functional film 515 can be the same or can be different than the functional film 115. In other instances, the functional film 515 can include the same material layers as the functional film 115, but the arrangement of the film 515 can be different than the arrangement of the film layers 115 relative to a surface of the core 110 or the core 310. For example, the functional films 115, 515 each can be a bi-layer film including a polyolefin layer and a polyamide or copolyamide layer, but the polyamide or copolyamide layer in the film 515 can be adjacent to a surface of the core 110 or the core 310 whereas the polyolefin layer in the film 115 can be adjacent to the core 110 or core 310.

In other embodiments, the functional film 115 can act to adhere or bond the underlying core to a skin or covering layer as shown in FIG. 7 and FIG. 8. In FIG. 7, a skin 730 is shown as being bonded to a paper honeycomb core 110 through the functional film 115. In FIG. 8, the skin 720 is shown as being bonded to a porous thermoplastic core layer 310 through the functional film 115. The functional film 115 used with different types of core layers and/or different types of skin can be different. For example, where the skin 730 comprises a single layer of material, the film 115 may be different than a film used with a skin 730 comprising a bi-laminate material or a tri-laminate material. Illustrations of various skins are discussed in more detail below. The film 115 used to bond the skin 730 to the underlying core typically comprises a “heavy” film with a basis weight of 75 g/m² or more as discussed below. Further, the film 115 used with the skin 730 can include one or more of a polyamide, a copolyamide, a polyolefin or metal particles in one or more layers of the film 115. While not required, in some arrangements a layer of the film 115 which includes a polyamide, a copolyamide, or metal particles can be placed adjacent to a surface of the core 110 or the core 310 to enhance bonding of the film 115 to the core.

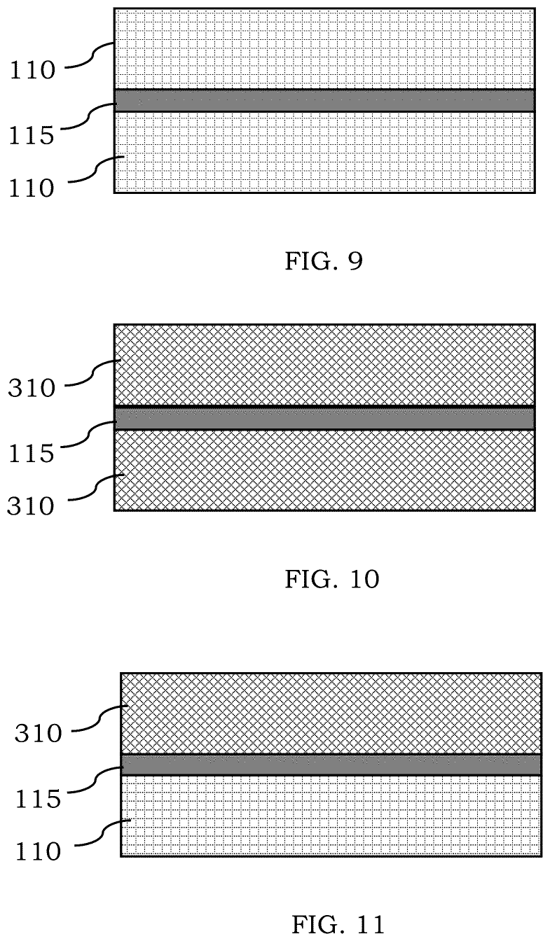

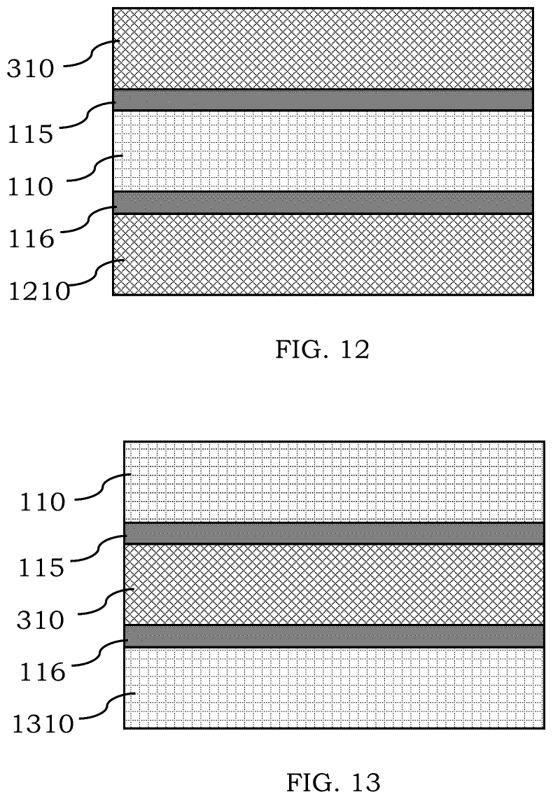

In certain embodiments, the functional films described herein can be used to bond core layers to each other. An illustration is shown in FIG. 9 where two paper honeycomb core layers 310 are bonded to each other through a functional film 115. FIG. 10 is an illustration where two porous thermoplastic core layers 310 are bonded to each other through a functional film 115. FIG. 11 is an illustration where a paper honeycomb core 110 is bonded to a porous thermoplastic core layer 310 through a functional film 115. FIG. 12 is an illustration showing a paper honeycomb core 110 bonded to a first porous thermoplastic core 310 through a functional film 115 and to a second porous thermoplastic core 1210 through another functional film 116. FIG. 13 is an illustration showing a porous thermoplastic core 310 bonded to a first paper honeycomb core 110 through a functional film 115 and bonded to a second paper honeycomb core 1310 through a functional film 116. Where two or more functional films 115, 116 are present in any one assembly, the functional films 115, 116 can be the same or can be different or can include similar layers with a different arrangement of layers relative to a specific core surface.

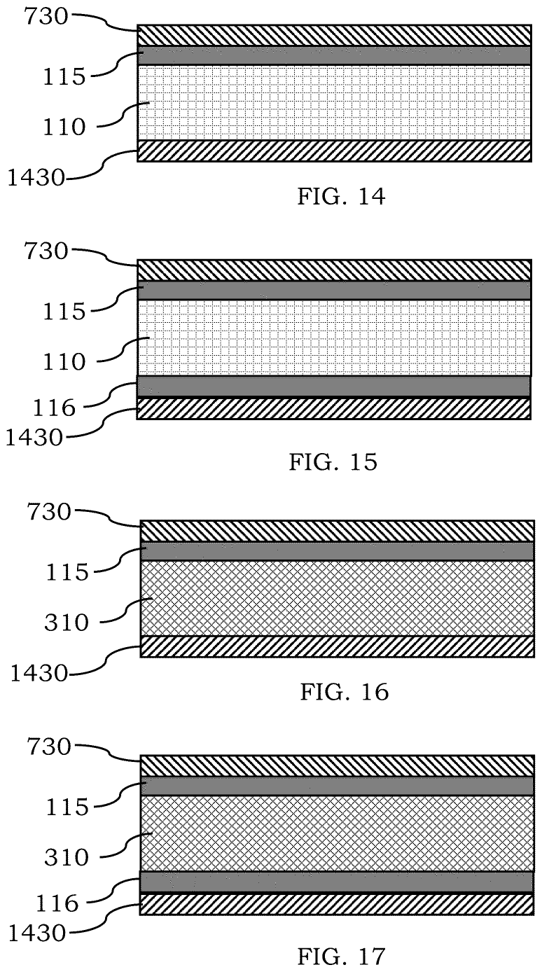

In certain configurations, the composite articles described herein can include a core layer bonded to two or more skin layers. Referring to FIG. 14, a paper honeycomb core 110 is bonded to a first skin 730 through a functional film 115 and to a second skin 1430 directly to the core 110. If desired, a second functional film 116 can be present between the second skin 1430 and the core 110 as shown in FIG. 15. In other configurations, a porous thermoplastic core 310 can be bonded to a first skin 730 through a functional film 115 and to a second skin 1430 directly to the core 310 (see FIG. 16). In some instances, a second functional film 116 can be present between the second skin 1430 and the core 310 as shown in FIG. 17.

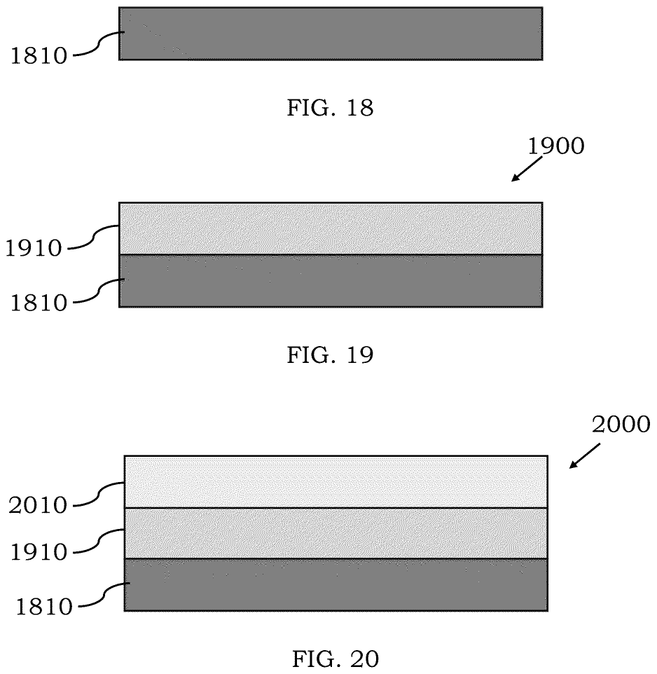

In some embodiments, the functional films described can include one or more materials which are effective to bond a core layer to another layer. The exact materials and arrangement present can vary depending on the particular materials present in the core and/or any skin. For example, the functional film can include one or more of a polyamide, a co-polyamide, metal particles, a metal coating, a metal layer or combinations thereof. If desired, the functional film can also include a polyolefin, polyethylene terephthalate, or other materials which can be present in polymer or fiber form as desired. These different materials can be present in the same layer or in different layers of the film. In certain embodiments, the functional film can be a single layer film, a bi-layer film, a tri-layer film or have more than three layers. Any one or more layers of the film can be perforated if desired or can include areas which are perforated. Referring to FIG. 18, a single layer film 1810 is shown that comprises one or more of a polyamide, a co-polyamide, metal particles, a polyolefin, polyethylene terephthalate, or other materials which can be present in polymer or fiber form in the single layer film 1810. In certain embodiments, a basis weight of the single layer film 1810 can be 70 g/m² (gsm) or more, more particularly 70-150 gsm or 80-120 gsm or 80-100 gsm or 70 gsm, 75 gsm, 80 gsm, 85 gsm, 90 gsm, 95 gsm, 100 gsm, 110 gsm, 120 gsm, 130 gsm, 140 gsm or 150 gsm.

In other configurations, the functional film can be a bi-layer film 1900 as shown in FIG. 19 where one film layer 1810 is coupled to a second film layer 1910. The film layers 1810, 1910 typically include different materials which are selected to adhere to different components in the LWRT composite article. For example, the film layer 1810 can include one or more of a polyamide, a co-polyamide, metal particles, a polyolefin, polyethylene terephthalate, or other materials which can be present in polymer or fiber form in the film layer 1810 of the bi-layer film 1900. The second layer 1910 can also include one or more of a polyamide, a co-polyamide, metal particles, a polyolefin, polyethylene terephthalate, or other materials which can be present in polymer or fiber form in the film layer 1910. The amount and/or type of materials present in the layers 1810, 1910 is typically different. For example, the layer 1810 can include suitable materials to bond to an underlying core layer (not shown), and the layer 1910 can include suitable material to bond to a covering or skin layer (not shown).

In some embodiments, one of the layers 1810, 1910 comprises a polyamide or a copolyamide, and the other layer of the layers 1810, 1910 comprises a polyolefin including but not limited to, polyethylene, polypropylene or co-polymers thereof. In another configuration, one of the layers 1810, 1910 comprises a polyamide or a copolyamide in combination with a polyolefin, and the other layer of the layers 1810, 1910 comprises a polyolefin including but not limited to, polyethylene, polypropylene or co-polymers thereof. In an additional configuration, one of the layers 1810, 1910 comprises a polyamide or a copolyamide in combination with a polyethylene terephthalate, and the other layer of the layers 1810, 1910 comprises a polyolefin including but not limited to, polyethylene, polypropylene or co-polymers thereof. In another embodiment, one of the layers 1810, 1910 comprises a polyamide or a copolyamide in combination with metal particles, and the other layer of the layers 1810, 1910 comprises a polyolefin including but not limited to, polyethylene, polypropylene or co-polymers thereof. In an additional embodiment, one of the layers 1810, 1910 comprises a polyamide or a copolyamide, and the other layer of the layers 1810, 1910 comprises metal particles or is a metal film layer. In another additional embodiment, one of the layers 1810, 1910 comprises a polyamide or a copolyamide, and the other layer of the layers 1810, 1910 comprises metal particles and a polyolefin. In an additional embodiment, one of the layers 1810, 1910 comprises a polyamide or a copolyamide, and the other layer of the layers 1810, 1910 comprises metal particles and a polyethylene terephthalate. In another embodiment, one of the layers 1810, 1910 comprises a polyamide, and the other layer of the layers 1810, 1910 comprises a copolyamide. In an additional embodiment, one of the layers 1810, 1910 comprises a polyolefin, and the other layer of the layers 1810, 1910 comprises a copolyamide. In another embodiment, one of the layers 1810, 1910 comprises a polyethylene terephthalate, and the other layer of the layers 1810, 1910 comprises a copolyamide. In an additional embodiment, one of the layers 1810, 1910 comprises a polyolefin, and the other layer of the layers 1810, 1910 comprises a polyamide. In another embodiment, one of the layers 1810, 1910 comprises a polyethylene terephthalate, and the other layer of the layers 1810, 1910 comprises a polyamide. Additional materials for the film layers 1810, 1910 are also possible.

In certain embodiments, a basis weight of the bi-layer film 1900 can be 70 g/m² (gsm) or more, more particularly 70-150 gsm or 80-120 gsm or 80-100 gsm or 70 gsm, 75 gsm, 80 gsm, 85 gsm, 90 gsm, 95 gsm, 100 gsm, 110 gsm, 120 gsm, 130 gsm, 140 gsm or 150 gsm. In other embodiments, the basis weight of each of the film layers 1810, 1910 can independently be 70-150 gsm or 80-120 gsm or 80-100 gsm or 80 gsm, 90 gsm, 100 gsm, 110 gsm, 120 gsm, 130 gsm, 140 gsm or 150 gsm. In some embodiments, one of the film layers 1810, 1910 comprises a basis weight of 10-50 gsm and the other of the film layers comprises a basis weight so the total basis weight of the bi-layer film is between 75-150 gsm.

In other configurations, the functional film can be a tri-layer film 2000 as shown in FIG. 20 where one film layer 1810 is coupled to a second film layer 1910 and the second film layer 1910 is coupled to a third film layer 2010. The film layers 1810, 1910, 2010 typically include different materials which are selected to adhere to different components in the LWRT composite article. For example, the film layer 1810 can include one or more of a polyamide, a co-polyamide, metal particles, a polyolefin, polyethylene terephthalate, or other materials which can be present in polymer or fiber form in the film layer 1810 of the tri-layer film 2000. Each of the second layer 1910 and the third layer 2010 can independently include one or more of a polyamide, a co-polyamide, metal particles, a polyolefin, polyethylene terephthalate, or other materials which can be present in polymer or fiber form in the film layer 1910 or the film layer 2010. The amount and/or type of materials present in the layers 1810, 1910, 2010 is typically different. For example, the layer 1810 can include suitable materials to bond to an underlying core layer (not shown), and the layer 2010 can include suitable materials to bond to a covering or skin layer (not shown). The layer 1910 can function as a tie layer to bond the film layer 1810 to the film layer 2010 if desired. In other arrangements, the layer 1910 can be, for example, a metallized film layer to provide some barrier properties, e.g., water resistance, between a core layer and any skin layer.

In some embodiments, one of the layers 1810, 1910, 2010 comprises a polyamide or a copolyamide, and at least one of the other layers of the layers 1810, 1910, 2010 comprises a polyolefin including but not limited to, polyethylene, polypropylene or co-polymers thereof. In another configuration, one of the layers 1810, 1910, 2010 comprises a polyamide or a copolyamide in combination with a polyolefin, and at least one of the other layers of the layers 1810, 1910, 2010 comprises a polyolefin including but not limited to, polyethylene, polypropylene or co-polymers thereof. In an additional configuration, one of the layers 1810, 1910, 2010 comprises a polyamide or a copolyamide in combination with a polyethylene terephthalate, and at least one of the other layers of the layers 1810, 1910, 2010 comprises a polyolefin including but not limited to, polyethylene, polypropylene or co-polymers thereof. In another embodiment, one of the layers 1810, 1910, 2010 comprises a polyamide or a copolyamide in combination with metal particles, and at least one of the other layers of the layers 1810, 1910, 2010 comprises a polyolefin including but not limited to, polyethylene, polypropylene or co-polymers thereof. In an additional embodiment, one of the layers 1810, 1910, 2010 comprises a polyamide or a copolyamide, and at least one of the other layers of the layers 1810, 1910, 2010 comprises metal particles or is a metal film layer. In another additional embodiment, one of the layers 1810, 1910, 2010 comprises a polyamide or a copolyamide, and at least one of the other layers of the layers 1810, 1910, 2010 comprises metal particles and a polyolefin. In an additional embodiment, one of the layers 1810, 1910, 2010 comprises a polyamide or a copolyamide, and at least one of the other layers of the layers 1810, 1910, 2010 comprises metal particles and a polyethylene terephthalate. In another embodiment, one of the layers 1810, 1910, 2010 comprises a polyamide, and at least one of the other layer of the layers 1810, 1910, 2010 comprises a copolyamide. In an additional embodiment, one of the layers 1810, 1910, 2010 comprises a polyolefin, and at least one of the other layers of the layers 1810, 1910, 2010 comprises a copolyamide. In another embodiment, one of the layers 1810, 1910, 2010 comprises a polyethylene terephthalate, and at least one of the other layers of the layers 1810, 1910, 2010 comprises a copolyamide. In an additional embodiment, one of the layers 1810, 1910, 2010 comprises a polyolefin, and at least one of the other layers of the layers 1810, 1910, 2010 comprises a polyamide. In another embodiment, one of the layers 1810, 1910, 2010 comprises a polyethylene terephthalate, and at least one of the other layers of the layers 1810, 1910, 2010 comprises a polyamide. Additional materials for the film layers 1810, 1910, 2010 are also possible.

In certain embodiments, a basis weight of the tri-layer film 2000 can be 70 g/m² (gsm) or more, more particularly 70-150 gsm or 80-120 gsm or 80-100 gsm or 80 gsm, 90 gsm, 100 gsm, 110 gsm, 120 gsm, 130 gsm, 140 gsm or 150 gsm. In other embodiments, the basis weight of each of the film layers 1810, 1910, 2010 can independently be 70-150 gsm or 80-120 gsm or 80-100 gsm or 80 gsm, 90 gsm, 100 gsm, 110 gsm, 120 gsm, 130 gsm, 140 gsm or 150 gsm. In some embodiments, one of the film layers 1810, 1910, 2010 comprises a basis weight of 10-50 gsm and the other two film layers comprise a basis weight so the total basis weight of the tri-layer film is between 70-150 gsm.

In certain embodiments, functional films with four layers, five layers, six layer or more can also be used. Any one or more of the layers in a multi-layer film can include any of those materials described in reference to the layers 1810, 1910 and 2010. Further, film stacks can be produced by coupling single layer films to a bi-layer film, by coupling a single layer film to a tri-layer film, by coupling two bi-layer films to each other, by coupling a bi-layer film to a tri-layer film or by coupling two tri-layer films to each other. As noted herein, different materials in the different layers can be selected depending on the particular composite article component intended to bond with a particular film surface.

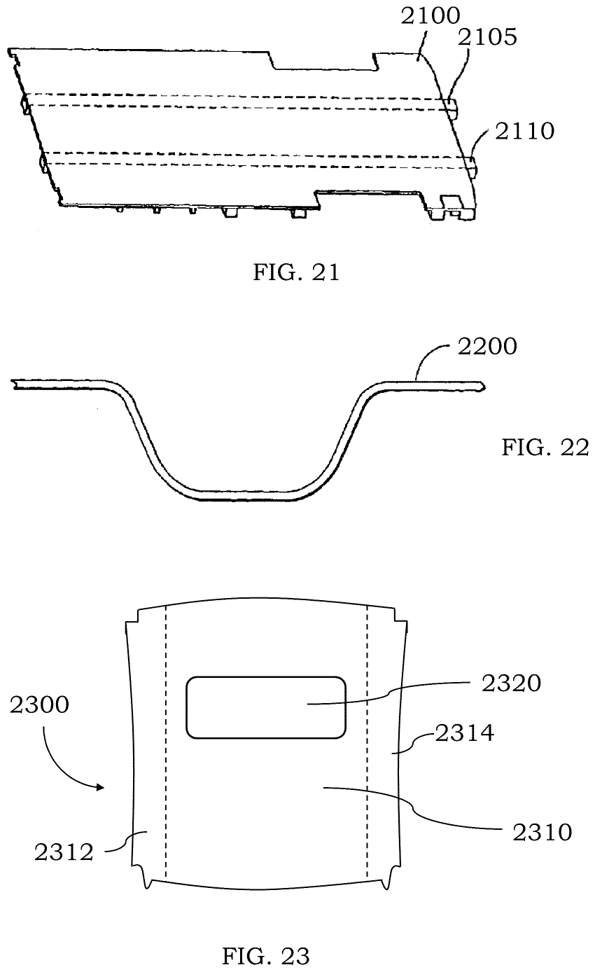

The functional films described herein can be used in composite articles which can be processed into a desired configuration or shape using suitable processes including, but not limited to, molding, thermoforming, drawing or other forming processes. In some instances, such processes are used to impart a desired configuration and/or to loft the various layers of the composite article. For example, where the article is designed to function as a vehicle floor, the floor may be shaped and/or cut in a desired manner. Referring to FIG. 21, a vehicle floor 2100 is shown as being disposed and coupled to a vehicle frame comprising components 2105, 2110. The floor 2100 is a generally planar structure comprising one or more of the composite articles described herein which include a functional film. The floor 7210 may be coupled to the vehicle frame through suitable fasteners such as bolts, screws and the like and optionally with one or more adhesives. In some instances, doors, a roof assembly and other components of the vehicle may be disposed onto the floor 2100 to provide a user cabin. If desired, a carpet, foam padding, and the like may be coupled to the floor 700 for aesthetic or other reasons.

In certain embodiments, a load floor for a rear storage compartment may be produced using the articles described herein. Referring to FIG. 22, a side view of a drawn article 2200 that can be used as a load floor is shown. The article 2200 is typically positioned in the rear portion of the vehicle, e.g., a rear storage portion of a sport utility vehicle or minivan, and is designed to receive components, gear, luggage, a spare tire, etc. for storage. A lid or covering (not shown) may also be present to enclose the components within the load floor 2200 and shield them from view. The load floor 2200 may comprise, for example, a composite article including a functional film as described herein .. In some instances, the load floor 2200 provides sufficient weight bearing capacity so that no underlying support members from the vehicle need be present to support it.

In certain examples, the composite articles including a functional film described herein can be used in composite articles configured for interior uses in automotive vehicles such as cars, buses, trucks, etc. One illustration (top view) of an automotive or vehicle headliner is shown in FIG. 23. The headliner 2300 comprises a body 2310 and an optional opening 2320, e.g., for a sunroof, moonroof, etc. The body of the headliner 2310 can be produced by initially heating a composite article as described herein to a desired temperature in an oven, e.g., about 210-230° C., and then moving to a molding machine where a decorative fabric can be placed on the core layer and pressed with the desired mold to convert the article into a headliner. The opening 2320 may then be provided by trimming the headliner 2300. The non-visible surface of the headliner, e.g., the surface which rests against the roof of the vehicle may comprise one or more additional layers or an adhesive as desired. In addition, the non-visible surface may also comprise its own skin layer, decorative layer, etc. which can function, at least some degree, as an adhesive. The overall shape and geometry of the headliner 2300 may be selected based on the area of the vehicle which the headliner is to be coupled. For example, the length of the headliner 2300 can be sized and arranged so it spans from the front windshield to the rear windshield, and the width of the headliner 2300 can be sized and arranged so it spans from the left side of the vehicle to the right side of the vehicle. In some examples, edges 2312, 2314 can have a lower basis weight than a central area of the body 2310 to permit proper side air bag deployment, e.g., to permit failure of the headliner at the edges 2312, 2314 when side air bags are deployed. Alternatively, the entire vehicle headliner could have a generally constant basis weight across a width of the body 2310.

In certain embodiments, the paper honeycomb cores described herein can be produced by coupling together separate bands of kraft paper to form continuous hexagonal cells, then bonding these to flat, outer layers to create a strong, lightweight “sandwich” assembly or sandwich structure. The different bands are typically joined using an adhesive or glue. The formed paper honeycomb core can then be fed through an inline process as noted below in connection with the porous thermoplastic core to laminate a functional film and/or skin layers to a surface of the paper honeycomb core in an automated manner.

In some embodiments, the porous thermoplastic cores descried herein can include a web of open cell structures formed from reinforcing materials held in place by a thermoplastic material. For example, the porous thermoplastic core can be formed from a random arrangement of reinforcing materials that are held in place by the thermoplastic material, e.g., a thermoplastic resin material. The reinforcing materials may be reinforcing fibers, whiskers or other materials that can impart some reinforcement to the Composite articles. The porous thermoplastic core typically comprises a substantial amount of open cell structure such that void space is present in the porous thermoplastic core. In some instances, the porous thermoplastic core may comprise a void content or porosity of 0-30%, 10-40%, 20-50%, 30-60%, 40-70%, 50-80%, 60-90%, 0-40%, 0-50%, 0-60%, 0-70%, 0-80%, 0-90%, 10-50%, 10-60%, 10-70%, 10-80%, 10-90%, 10-95%, 20-60%, 20-70%, 20-80%, 20-90%, 20-95%, 30-70%, 30-80%, 30-90%, 30-95%, 40-80%, 40-90%, 40-95%, 50-90%, 50-95%, 60-95% 70-80%, 70-90%, 70-95%, 80-90%, 80-95% or any illustrative value within these exemplary ranges. The overall thickness of the porous thermoplastic core may vary from about 0.1 mm to about 15 mm and may change if the porous thermoplastic core is compressed during processing or expanded due to lofting.

In certain embodiments, the thermoplastic material used to form the porous thermoplastic core described herein may include one or more of a polyolefin (e.g., one or more of polyethylene, polypropylene, etc.), polystyrene, acrylonitrylstyrene, butadiene, polyethyleneterephthalate, polybutyleneterephthalate, polybutylenetetrachlorate, and polyvinyl chloride, both plasticized and unplasticized, and blends of these materials with each other or other polymeric materials. Other suitable thermoplastics include, but are not limited to, polyarylene ethers, polycarbonates, polyestercarbonates, thermoplastic polyesters, polyimides, polyetherimides, polyamides, co-polyamides, acrylonitrile-butylacrylate-styrene polymers, amorphous nylon, polyarylene ether ketone, polyphenylene sulfide, polyaryl sulfone, polyether sulfone, liquid crystalline polymers, poly(1,4 phenylene) compounds commercially known as PARMAX®, high heat polycarbonate such as Bayer's APEC® PC, high temperature nylon, and silicones, as well as copolymers, alloys and blends of these materials with each other or other polymeric materials. The thermoplastic material used to form the porous thermoplastic core can be used in powder form, resin form, rosin form, particle form, fiber form or other suitable forms. Illustrative thermoplastic materials in various forms are described herein and are also described, for example in U.S. Publication Nos. 20130244528 and US 20120065283. The exact amount of thermoplastic material present in the porous thermoplastic core can vary and illustrative amounts range from about 20% by weight to about 80% by weight, e.g., 30-70 percent by weight or 35-65 percent by weight, based on the total weight of the porous thermoplastic core. It will be recognized by the skilled person that the weight percentages of all materials used in the porous thermoplastic core will add to 100 weight percent. The thermoplastic material can include virgin materials, recycled or reproduced materials or both. For example, the thermoplastic material can include recycled thermoplastic material to increase the sustainability of the composite articles.

In certain embodiments, the reinforcing materials of the porous thermoplastic core described herein may comprise glass fibers, carbon fibers, graphite fibers, synthetic organic fibers, particularly high modulus organic fibers such as, for example, para-and meta-aramid fibers, nylon fibers, polyester fibers, a high melt flow index resin (e.g., 100 g/10 min. MFI or above) that is suitable for use as fibers, mineral fibers such as basalt, mineral wool (e.g., rock or slag wool), wollastonite, alumina silica, and the like, or mixtures thereof, metal fibers, metalized natural and/or synthetic fibers, ceramic fibers, yarn fibers, or mixtures thereof. In other embodiments, the porous thermoplastic core can include reproduced polymeric fibers, bi-component fibers, e.g., sheath-core fibers, or fibers produced from recycled materials. In some embodiments, any of the aforementioned fibers can be chemically treated prior to use to provide desired functional groups or to impart other physical properties to the fibers, e.g., may be chemically treated so that they can react with the thermoplastic material, the lofting agent or both. The fiber content in the porous thermoplastic core may independently be from about 20% to about 80% by weight of the porous thermoplastic core, more particularly from about 30% to about 70%, by weight of the porous thermoplastic core or 25% by weight to 65% by weight of the porous thermoplastic core or 20% by weight to 60% by weight of the porous thermoplastic core. The particular size and/or orientation of the fibers used may depend, at least in part, on the thermoplastic material used and/or the desired properties of the porous thermoplastic core. In one non-limiting illustration, fibers dispersed within a thermoplastic material and optionally other additives to provide the porous thermoplastic cores can generally have a diameter of greater than about 5 microns, more particularly from about 5 microns to about 22 microns, and a length from about 5 mm to about 200 mm, more particularly, the fiber diameter may be from about 2 microns to about 22 microns and the fiber length may be from about 5 mm to about 75 mm.

In other embodiments, other additives may also be present in the porous thermoplastic core comprising the thermoplastic resin and the reinforcing materials. For example, a lofting agent, flame retardants, colorants, smoke suppressants, surfactants, foams or other materials may be present in the porous thermoplastic core. If desired, recycled materials, biomaterials, bioparticles, ground natural material or other sustainable materials can be included in the porous thermoplastic cores. In some examples, the porous thermoplastic core may substantially halogen free or halogen free porous thermoplastic core to meet the restrictions on hazardous substances requirements for certain applications. In other instances, the porous thermoplastic core may comprise a halogenated flame retardant agent such as, for example, a halogenated flame retardant that comprises one of more of F, Cl, Br, I, and At or compounds that including such halogens, e.g., tetrabromo bisphenol-A polycarbonate or monohalo-, dihalo-, trihalo- or tetrahalo-polycarbonates. In some instances, the thermoplastic material used in the porous thermoplastic cores may comprise one or more halogens to impart some flame retardancy without the addition of another flame retardant agent. Where halogenated flame retardants are present, the flame retardant is desirably present in a flame retardant amount, which can vary depending on the other components which are present. For example, the halogenated flame retardant may be present in about 0.1 weight percent to about 15 weight percent (based on the weight of the porous thermoplastic core), more particularly about 1 weight percent to about 13 weight percent, e.g., about 5 weight percent to about 13 weight percent based on the weight of the porous thermoplastic core. If desired, two different halogenated flame retardants may be added to the layers. In other instances, a non-halogenated flame retardant agent such as, for example, a flame retardant agent comprising one or more of N, P, As, Sb, Bi, S, Se, and Te can be added. In some embodiments, the non-halogenated flame retardant may comprise a phosphorated material so the layers may be more environmentally friendly. Where non-halogenated or substantially halogen free flame retardants are present, the flame retardant is desirably present in a flame retardant amount, which can vary depending on the other components which are present. For example, the substantially halogen free flame retardant may be present in about 0.1 weight percent to about 15 weight percent (based on the weight of the layer), more particularly about 1 weight percent to about 13 weight percent, e.g., about 5 weight percent to about 13 weight percent based on the weight of the porous thermoplastic core. If desired, two different substantially halogen free flame retardants may be added to one or more of the porous thermoplastic cores described herein. In certain instances, one or more of the porous thermoplastic cores described herein may comprise one or more halogenated flame retardants in combination with one or more substantially halogen free flame retardants. Where two different flame retardants are present, the combination of the two flame retardants may be present in a flame retardant amount, which can vary depending on the other components which are present. For example, the total weight of flame retardants present may be about 0.1 weight percent to about 20 weight percent (based on the weight of the layer), more particularly about 1 weight percent to about 15 weight percent, e.g., about 2 weight percent to about 14 weight percent based on the weight of the porous thermoplastic core. The flame retardant agents used in the layers described herein can be added to the mixture comprising the thermoplastic material and fibers (prior to disposal of the mixture on a wire screen or other processing component) or can be added after the layer is formed. In some examples, the flame retardant material may comprise one or more of expandable graphite materials, magnesium hydroxide (MDH) and aluminum hydroxide (ATH).

In some embodiments, metal materials may also be present within the porous thermoplastic core. The metal materials may be the same as or different than those metal materials present in the functional film layers described herein.

The exact thickness and basis weight of the porous thermoplastic cores and composite article may vary. For example, the porous thermoplastic core may have a basis weight of 300 grams/m2 (gsm) up to 3500 gsm. Depending on the particular porous thermoplastic cores which are used, the porous thermoplastic core may have a basis weight of 100 gsm up to 3500 gsm. The thickness of the porous thermoplastic core can vary from about 1 mm to about 15 mm, more particularly about 2 mm to about 15 mm or 3 mm to about 15 mm or 4 mm to about 15 mm or 5 mm to about 15 mm. The composite article is generally thicker than the porous thermoplastic core.

The composite articles can also include additional layers on one or more surface of the ore. For example, one or more other skins can be present in the composite articles. The various skins described herein can take numerous forms including a film (closed cell, open cell, perforated, etc.), a scrim, a frim (film+scrim), a foil, a woven fabric, a non-woven fabric or be present as an inorganic coating, an organic coating, or a thermoset coating. In other instances, the skin may comprise a limiting oxygen index greater than about 22, as measured per ISO 4589 dated 1996. Where a fiber based scrim is present as (or as part of) the skin, the fiber based scrim may comprise at least one of glass fibers, aramid fibers, graphite fibers, carbon fibers, inorganic mineral fibers, metal fibers, metalized synthetic fibers, and metalized inorganic fibers. If desired, the scrim may comprise materials or fibers produced from one or more of the thermoplastic materials described above in connection with the porous thermoplastic cores. Where a thermoset coating is present as (or as part of) the skin layer, the coating may comprise at least one of unsaturated polyurethanes, vinyl esters, phenolics and epoxies. Where an inorganic coating is present as (or as part of) the skin layer, the inorganic coating may comprise minerals containing cations selected from Ca, Mg, Ba, Si, Zn, Ti and Al or may comprise at least one of gypsum, calcium carbonate and mortar. Where a non-woven fabric is present as (or as part of) the skin layer, the non-woven fabric may comprise a thermoplastic material, a thermal setting binder, inorganic fibers, metal fibers, metallized inorganic fibers and metallized synthetic fibers. If desired, the skin layer may also comprise a lofting agent, an expandable graphite material, a flame retardant material, bicomponent fibers, biaxially oriented fibers, reproduced fibers, polymeric fibers, natural fibers, natural particles, bioparticles, biofillers, etc. The skin layers may have open cell structure to permit sound waves to travel into the coupled porous thermoplastic cores to enhance sound absorption by a composite article including the porous thermoplastic core and the skin layer. In some embodiments, the skin comprises a bi-laminate material or a tri-laminate material which can be laminated to the functional film in an inline process as described in more detail below. In other instances, the skin may be, or function as, a water barrier film (WRB layer) and typically comprises polyolefin materials and/or polyolefin fibers optionally with additives including metals, metal particles, amines, amides, fluoro compounds or other materials. In some configurations, the WRB layer can be a single layer film, a bilayer film or a multilayer film that includes a polyolefin/metal layer (e.g., aluminum)/a polyethylene terephthalate. For example, biaxially oriented polyethylene terephthalate can be present as one layer of a multilayer film. The skins used herein can be perforated or can generally be solid. A basis weight of the skin can vary from 25 gsm to 500 gsm.

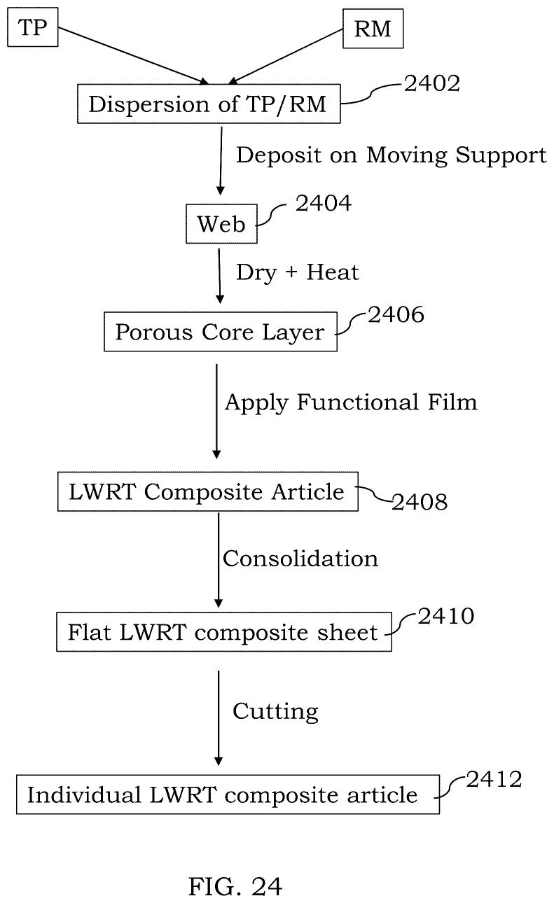

In certain embodiments, an in-line process to produce a composite article including a functional film can include numerous steps which are typically controlled in an automated manner using a processor or computer as described in more detail below. Certain steps of the process, and the various materials used/produced by each step, are shown by way of the block diagram in FIG. 24. A LWRT composite article is prepared by combining a thermoplastic material (TP, e.g., a thermoplastic resin and reinforcing materials (RM) to form a dispersion or mixture 2402. This mixture can then be deposited onto a suitable moving support to provide a web 2404 formed by the reinforcing materials and the thermoplastic resin. The resulting web can include open cell structures of reinforcing fibers held in place by the thermoplastic material. The resulting web can be heated and dried to soften or melt the thermoplastic resin and form a porous thermoplastic core layer 2406. One or more functional films can then be applied to a surface of the formed and heated porous thermoplastic core layer. For example, a functional film can be applied to form a LWRT composite article 2408. The resulting LWRT composite can be consolidated into a flat sheet 2410, which can be used in forming the floors, headliners or other articles described herein. For example, the flat sheet 2410 on the moving support can be cut to provide an individual LWRT composite article 2412. Various illustrations of process conditions, steps and materials are described in more detail below.

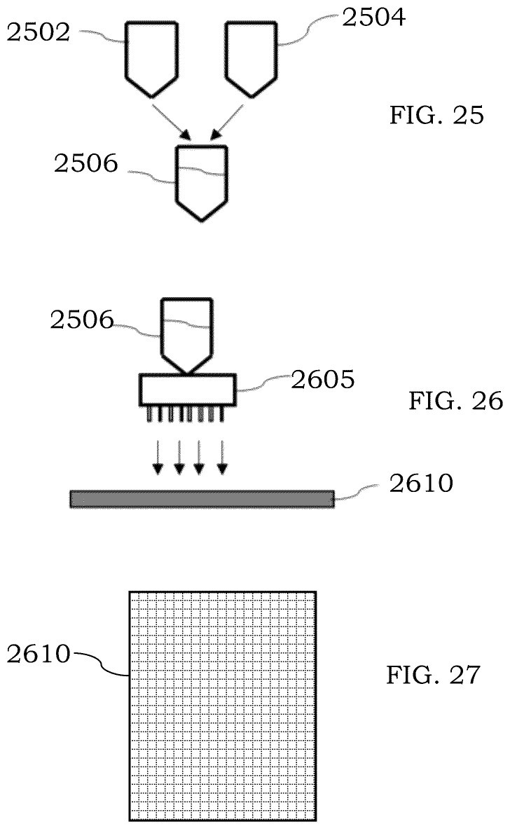

As shown in FIG. 25, a thermoplastic material can be present in a reservoir 2502 and reinforcing fibers (or other reinforcing materials) can be present in a second reservoir 2504. Each of the thermoplastic material and the reinforcing fibers can be metered, sprayed, or otherwise introduced into an aqueous solution in a mixing tank 2506 comprising water, a liquid or an aqueous solution. If desired, a foam or other additives (as discussed below) may be present in the mixing tank 2506. The thermoplastic material and reinforcing fibers can be mixed for a suitable time and at a suitable temperature to provide a substantially homogenous aqueous dispersion of the fibers and the thermoplastic material. For example, the materials may be mixed at room temperature, e.g., about 25 deg. Celsius, or above room temperature or below room temperature by heating or cooling the mixing tank. In some embodiments, the materials can be added continuously into the mixing tank 2506 to permit continuous deposition of the dispersion onto a moving support as noted below. While the exact mixing time may vary depending on the materials used, illustrative mixing times include 10 seconds to about 10 minutes, more particularly about 30 seconds to about 5 minutes. As noted above, however, in instances where the materials are continuously added to the mixing tank 2506, mixing is performed constantly. The mixing tank 2506 can include a paddle mixer, an impeller or other devices to facilitate mixing.

In certain embodiments and referring to FIG. 26, the dispersion in the mixing tank 2506 can be sprayed, dripped or otherwise deposited onto a moving support 2610. While the moving support 2610 is shown as a single segment in certain figures depicted herein, the moving support 2610 could be broken up into two or more individual segments as desired. The mixing tank 2506 can be fluidically coupled to a plurality of spray heads 2605 that can spray the dispersion onto a surface of the moving support 2610. As shown in FIG. 27, the moving support 2610 can be porous or include a mesh that can receive the dispersion. The exact deposition rate used may vary depending on the amount of material to be deposited per square meter. The moving support 2610 may move at a continuous and constant speed to permit continuous spraying of the dispersion along a top surface of the moving support 2610. The area of the moving support 2610 under the spray heads may be heated, cooled or present at room temperature during deposition of the dispersion. As noted below, different areas of the moving support 2610 may have different temperatures. The exact dimensions of the moving support 2610 can vary and typically the moving support is about 4 feet wide and can include a mesh or pore size of about 60 openings/square inch to about 80 openings/square inch of moving support 2610. The moving support 2610 permits receipt of the dispersion and movement of the received dispersion to additional sites or stations of the in-line system. At the end of the moving support 2610, any formed LWRT composite articles can be cut and stacked. The moving support 2610 permits continuous formation of LWRT composite articles. In certain embodiments, the moving support 1610 can be split into two or more separate sections or segments. For example, a wet mat can be formed on a former belt and then transferred, e.g., manually or automatically, onto a separate dryer belt where it can pass through an oven or other drying device.

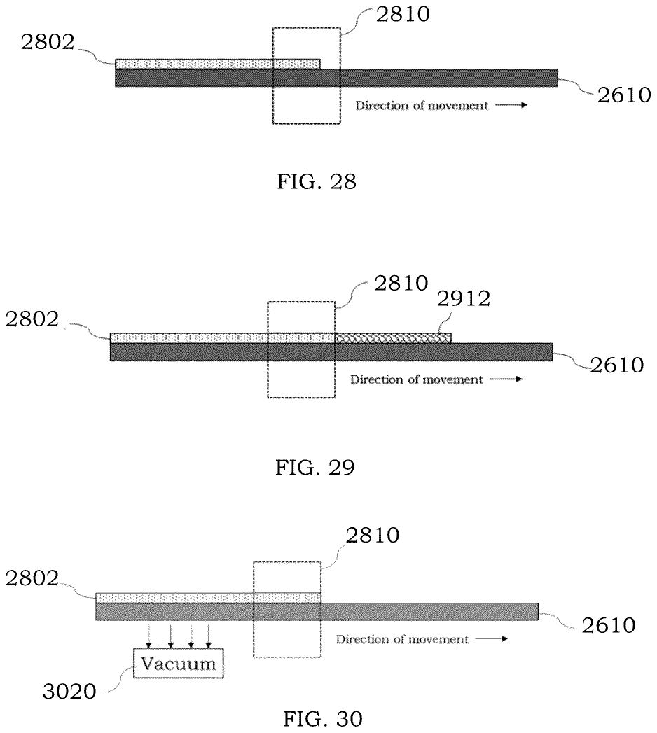

In certain embodiments and referring to FIG. 28, the moving support 2610 with the dispersion of the thermoplastic material and reinforcing fibers can migrate to a drying device 2810. The drying device 2810 can provide heat and/or a negative pressure (vacuum) to remove the water from the web 2802 on the moving support and leave behind the reinforcing fibers and the thermoplastic material on the moving support 2610. This process can form a porous thermoplastic core layer 2912 (see FIG. 29) with a high porosity that includes open cell structures formed from the reinforcing fibers that are held in place by the thermoplastic material. If desired, other materials may also be present in the core layer 2912 or sprayed onto the core layer 2912. For example, an adhesive from a reservoir can be sprayed on a surface of the formed core layer 2912. The exact temperature used to heat the web 2802 and/or core layer 2912 may vary and desirably the temperature is above a melting point of the thermoplastic material and below a melting point of the reinforcing fibers. In some examples, the moving support itself 2610 can be heated, whereas in other examples the drying device 2810 can include a heating element or be configured as an oven or other heating devices. If desired, the drying device 2810 and the moving support 2610 can both provide heat to the web 2802 on the moving support 2610. In some instances, the moving support 2610 can include a thermally conductive material that can retain the heat from the drying device 2810 to assist in maintaining the core layer 2912 in a softened form during application of skin layers or other materials. In some examples, a pressure device 3020 separate from the drying device 2810 may be present (see FIG. 30). For example, a vacuum may be applied to the web 2802 to remove water from the web and leave behind the reinforcing materials and the thermoplastic material. The pressure device 3020 is typically upstream of the drying device 2810 and is designed to remove at least 40% by volume of the water from the web 2802, more particularly about 60% by volume of the water from the web 2802. If desired, another pressure device (not shown) can be downstream of the pressure device 3020.

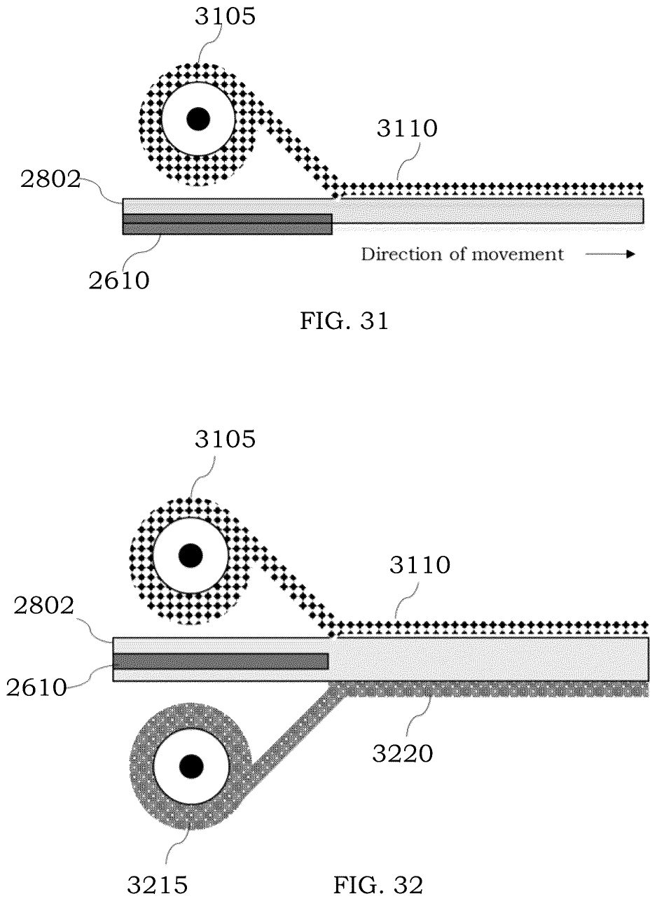

In certain embodiments, as the core layer 2912 exits the drying device 2810, one or more functional films and/or other layers can be applied to a surface of the core layer in an automated manner. Referring to FIG. 31, an illustration is shown where a functional film 3110 is applied to a core layer 2912 as the core layer 2912 exits the moving support 2610. For example, the functional film 3110 may be present as a roll of film material 3105 that is unrolled and applied in a continuous manner to one surface of the core layer 2912. As shown in FIG. 32, a second skin layer 3220, which can be another functional film or a type of skin, can be applied to a second surface of the core layer 2912 from a second roll 3215 including the second skin material. The layers 3110, 3220 can be applied at room temperature even though the core layer 2912 still may be heated otherwise be present on the moving support 2610 above room temperature. Alternatively, the rolls 3105, 3215 or layers 3110, 3220, or both, can be heated prior to being applied to the surfaces of the core layer 2912. The layers 3210, 3220 can generally be applied in a continuous manner to form a thermoplastic composite article that includes the core layer 2912, a functional film layer 3110 and optionally a second skin layer 3220. While not shown, additional skin layers can be applied on top of the layers 3110, 3220 using a similar process.

In certain embodiments, the resulting thermoplastic composite article can be consolidated by applying pressure to the surfaces of the composite article. For example, the composite article may pass between rollers to compress the composite article and enhance bonding of the functional film to the core. The exact distance or gap between the rollers may vary depending on the desired pressure to be applied and depending on a desired final thickness for the composite article. In general, an overall thickness of the composite article decreases after passing through the rollers. The rollers can be operated at room temperature, above room temperature or below room temperature. If desired, more than a single set of rollers can be present. For example, the gap between the different sets of rollers may be different. A first set of rollers may include a first gap that is less than a gap between a second set of rollers. The gap between the various rollers may be fixed or may vary. For example, it may be desirable to compress certain areas of the composite article to a greater degree so the thickness at these compressed areas is lower. In some instances, edges of the composite article can be compressed more so a thickness at the side edges of the composite article is lower. Three, four or more sets of rollers may be present if desired. The rollers can be positioned within an oven or heating device, if desired, to maintain the core layer in a softened form during consolidation of the composite article.

In certain embodiments, once the composite article is consolidated, the continuous sheet of consolidated composite article can be cut or guillotined into individual sheets using a cutting device. The resulting individual composite articles can be stacked or palletized, e.g., on pallet, for shipping. The resulting composite articles tend to be stacked as individual thin sheets with a thickness, for example, from 1 mm to about 50 mm. The exact size of the individual composite articles may vary from about 2 feet wide to about 8 feet wide and about 4 feet long to about 16 feet long. In some embodiments, the individual composite articles may be about 4 feet wide and about 8 feet long, so they have similar dimensions to plywood panels.

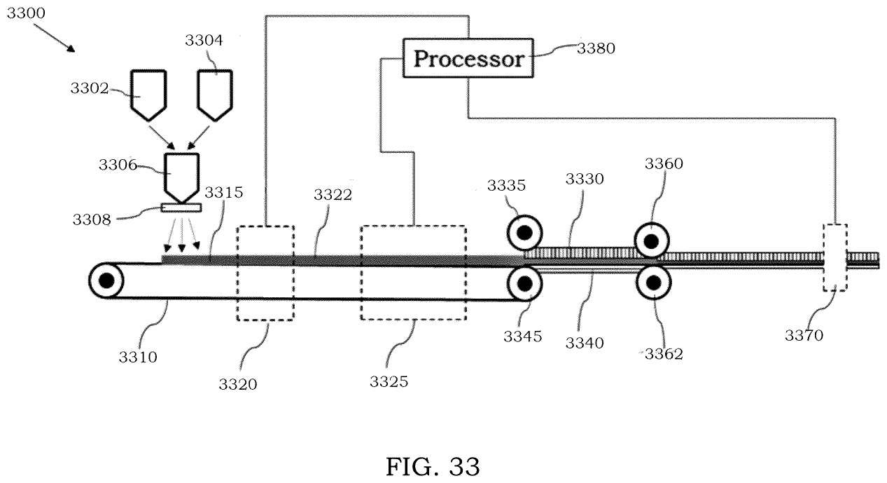

In certain configurations, a system can be used to implement the in-line process including the functional film. An illustration of components of the system are shown in FIG. 33. The system 3300 includes reservoirs 3302, 3304. Reservoir 3302 can receive a thermoplastic material, and reservoir 3304 can receive reinforcing materials, e.g., reinforcing fibers. The reservoirs 3302, 3304 can provide materials to a mixing tank 3306. The mixing tank 3306 can be fluidically coupled to a spray head or nozzles 3308 to spray the mixed dispersion onto a moving support 3310. The web 3315 on the moving support 3310 can travel through a vacuum or other pressure device 3320, which can remove the liquid from the web 3315 to form a porous thermoplastic core 3322. The core 3322 can pass through a drying device 3325 to dry and heat the core layer. Skin layers 3330, 3340 can be applied from supply devices or rolls 3335, 3345 respectively onto opposite surfaces of the core layer 3322 to provide a composite article. One or both of the skins 3330, 3340 can be a functional film as described herein. Additional supply rolls of other materials, e.g., skin, may also be present to apply additional layers on top or one or both of the skins 3330, 3340. The composite article can pass through a set of rollers 3360, 3362 to consolidate the composite article. The consolidated composite article can be cut into individual articles by cutting device 3370 as the sheet of moving, consolidated thermoplastic composite article passes through the cutting device 3370. A processor 3380 is shown that can control, for example, movement of the moving support 3310, spraying of the material onto the moving support 3310, and other devices and parameters used by the system 3300.

In embodiments where the core comprises a paper honeycomb layer, the paper honeycomb layer can be produced using automated paper making techniques or can be produced separately and then fed through a similar system as system 1100 to laminate a functional film and/or one or more skins to a surface of the paper honeycomb core. The resulting composite articles can be cut to size and stacked for further use.

In certain embodiments, the processor 3380 can control the in-line methods and in-line systems described herein. The processor 3380 can be part of the in-line system or otherwise electrically coupled to the in-line system through an associated device, e.g., computer, laptop, mobile device, etc. For example, the processor can be used to control the mixing speed of the materials, the speed of the moving support, the pressure used to remove liquid from the disposed dispersion, the temperature of the heating device(s), the pressure applied to the materials and other parameters of the process and system. Such processes may be performed automatically by the processor without the need for user intervention or a user may enter parameters through a user interface. In certain configurations, the processor may be present in one or more computer systems and/or common hardware circuity including, for example, a microprocessor and/or suitable software for operating the system, e.g., to control the various fluid reservoirs, mixing tank, pressure devices, speed, temperatures, etc. The processor can be integral to the in-line system or may be present on one or more accessory boards, printed circuit boards or computers electrically coupled to the components of the in-line system. The processor is typically electrically coupled to one or more memory units to receive data from the other components of the system and permit adjustment of the various system parameters as needed or desired. The processor may be part of a general-purpose computer such as those based on Unix, Intel PENTIUM-type processor, Intel Core™ processors, Intel Xeon™ processors, AMD Ryzen™ processors, AMD Athlon™ processors, AMD FX™ processors, Motorola PowerPC, Sun UltraSPARC, Hewlett-Packard PA-RISC processors, Apple-designed processors including Apple A14 Bionic processor, A13 Bionic processor, A12 processor, Apple A11 processor and others or any other type of processor. One or more of any type computer system may be used according to various embodiments of the technology. Further, the system may be connected to a single computer or may be distributed among a plurality of computers attached by a communications network. If desired, different components of the in-line system may be controlled by a respective processor or computer that is separate from a processor or computer used to control other components of the in-line system. It should be appreciated that other functions, including network communication, can be performed and the technology is not limited to having any particular function or set of functions. Various aspects may be implemented as specialized software executing in a general-purpose computer system. The computer system may include a processor connected to one or more memory devices, such as a disk drive, memory, or other device for storing data. Memory is typically used for storing programs, temperatures, moving support speeds and other values used in the in-line process. Components of the computer system may be coupled by an interconnection device, which may include one or more buses (e.g., between components that are integrated within a same machine) and/or a network (e.g., between components that reside on separate discrete machines). The interconnection device provides for communications (e.g., signals, data, instructions) to be exchanged between components of the system. The computer system typically can receive and/or issue commands within a processing time, e.g., a few milliseconds, a few microseconds or less, to permit rapid control of the system. The processor typically is electrically coupled to a power source which can, for example, be a direct current source, an alternating current source, a battery, a solar cell, a fuel cell or other power sources or combinations of power sources. The power source can be shared by the other components of the system. The system may also include one or more input devices, for example, a keyboard, mouse, trackball, microphone, touch screen, manual switch (e.g., override switch) and one or more output devices, for example, a printing device, display screen, speaker. In addition, the system may contain one or more communication interfaces that connect the computer system to a communication network (in addition or as an alternative to the interconnection device). The system may also include suitable circuitry to convert signals received from the various electrical devices present in the systems. Such circuitry can be present on a printed circuit board or may be present on a separate board or device that is electrically coupled to the printed circuit board through a suitable interface, e.g., a serial ATA interface, ISA interface, PCI interface, a USB interface, a Fibre Channel interface, a Firewire interface, a M.2 connector interface, a PCIE interface, a mSATA interface or the like or through one or more wireless interfaces, e.g., Bluetooth, Wi-Fi, Near Field Communication or other wireless protocols and/or interfaces.

In certain embodiments, the electronic storage system used in the systems described herein typically includes a computer readable and writeable nonvolatile recording medium in which codes of software can be stored that can be used by a program to be executed by the processor or information stored on or in the medium to be processed by the program. The medium may, for example, be a hard disk, solid state drive or flash memory. The program or instructions to be executed by the processor may be located locally or remotely and can be retrieved by the processor by way of an interconnection mechanism, a communication network or other means as desired. Typically, in operation, the processor causes data to be read from the nonvolatile recording medium into another memory that allows for faster access to the information by the processor than does the medium. This memory is typically a volatile, random access memory such as a dynamic random access memory (DRAM) or static memory (SRAM). It may be located in the storage system or in the memory system. The processor generally manipulates the data within the integrated circuit memory and then copies the data to the medium after processing is completed. A variety of mechanisms are known for managing data movement between the medium and the integrated circuit memory element and the technology is not limited thereto. The technology is also not limited to a particular memory system or storage system. In certain embodiments, the system may also include specially-programmed, special-purpose hardware, for example, an application-specific integrated circuit (ASIC), microprocessor units MPU) or a field programmable gate array (FPGA) or combinations thereof. Aspects of the technology may be implemented in software, hardware or firmware, or any combination thereof. Further, such methods, acts, systems, system elements and components thereof may be implemented as part of the systems described above or as an independent component. Although specific systems are described by way of example as one type of system upon which various aspects of the technology may be practiced, it should be appreciated that aspects are not limited to being implemented on the described system. Various aspects may be practiced on one or more systems having a different architecture or components. The system may comprise a general-purpose computer system that is programmable using a high-level computer programming language. The systems may be also implemented using specially programmed, special purpose hardware. In the systems, the processor is typically a commercially available processor such as the well-known microprocessors available from Intel, AMD, Qualcomm, Apple and others. Many other processors are also commercially available. Such a processor usually executes an operating system which may be, for example, the Windows 11 operating system available from the Microsoft Corporation, MAC OS X, e.g., Snow Leopard, Lion, Mountain Lion, Mojave, High Sierra, El Capitan or other versions available from Apple, the Solaris operating system available from Sun Microsystems, or UNIX or Linux operating systems available from various sources. Many other operating systems may be used, and in certain embodiments a simple set of commands or instructions may function as the operating system.

In certain examples, the processor and operating system may together define a platform for which application programs in high-level programming languages may be written. It should be understood that the technology is not limited to a particular system platform, processor, operating system, or network. Also, it should be apparent to those skilled in the art, given the benefit of this disclosure, that the present technology is not limited to a specific programming language or computer system. Further, it should be appreciated that other appropriate programming languages and other appropriate systems could also be used. In certain examples, the hardware or software can be configured to implement cognitive architecture, neural networks or other suitable implementations. If desired, one or more portions of the computer system may be distributed across one or more computer systems coupled to a communications network. These computer systems also may be general-purpose computer systems. For example, various aspects may be distributed among one or more computer systems configured to provide a service (e.g., servers) to one or more client computers, or to perform an overall task as part of a distributed system. For example, various aspects may be performed on a client-server or multi-tier system that includes components distributed among one or more server systems that perform various functions according to various embodiments. These components may be executable, intermediate (e.g., IL) or interpreted (e.g., Java) code which communicate over a communication network (e.g., the Internet) using a communication protocol (e.g., TCP/IP). It should also be appreciated that the technology is not limited to executing on any particular system or group of systems. Also, it should be appreciated that the technology is not limited to any particular distributed architecture, network, or communication protocol.

In some instances, various embodiments may be programmed using an object-oriented programming language, such as, for example, SQL, SmallTalk, Basic, Java, Javascript, PHP, C++, Ada, Python, iOS/Swift, Ruby on Rails or C # (C-Sharp). Other object-oriented programming languages may also be used. Alternatively, functional, scripting, and/or logical programming languages may be used. Various configurations may be implemented in a non-programmed environment (e.g., documents created in HTML, XML or other format that, when viewed in a window of a browser program, render aspects of a graphical-user interface (GUI) or perform other functions). Certain configurations may be implemented as programmed or non-programmed elements, or any combination thereof. In some instances, the systems may comprise a remote interface such as those present on a mobile device, tablet, laptop computer or other portable devices which can communicate through a wired or wireless interface and permit operation of the in-line system remotely as desired.

In certain examples, the processor may also comprise or have access to a database of information about specific articles to be produced. For example, specific parameters used to produce a composite article including a core layer and a functional film can be retrieved from the database and used by the in-line system. The instructions stored in the memory can execute a software module or control routine for the system, which in effect can provide a controllable model of the in-line system. The processor can use information accessed from the database together with one or software modules executed in the processor to determine control parameters or values for different components of the systems, e.g., different temperatures, different pressures, different consolidation devices, etc. Using input interfaces to receive control instructions and output interfaces linked to different system components in the system, the processor can perform active control over the system.

Certain specific examples are described to illustrate better some of the novel aspects and features of the technology described herein.

### Example 1

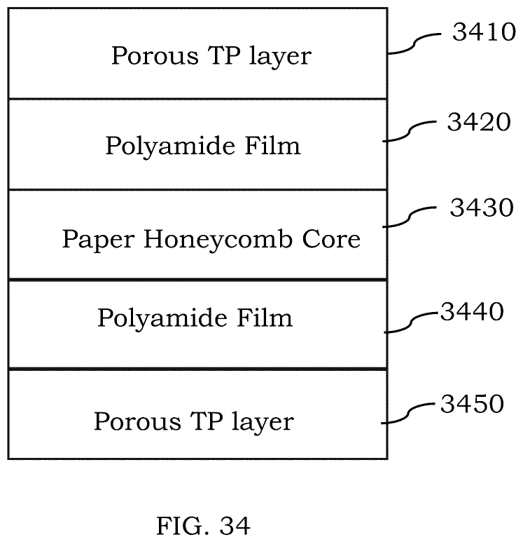

Several composite articles were produced and tested for their ability to be used as load floors in vehicle applications. The composite articles included the layers shown in FIG. 34 including a first thermoplastic porous layer 3410 (a 1500 gsm porous layer including glass fibers and polypropylene), a first functional film including a polyamide layer 3420 between the porous layer 3410 and a paper honeycomb core 3430, a second functional film including a polyamide layer 3440 and a second porous layer 3450 (a 900 gsm porous layer including glass fibers and polypropylene). Each of the films 3420, 3440 had a basis weight of 70 gsm and were solid and not perforated.

To test the assembly for its ability to function as a vehicle load floor, 95 kg of weight in the form of sandbags was placed on top of the layered assembly. The entire assembly was placed on a plate, and the level of deflection was measured after the layered assembly experienced three environmental cycles. Each environmental cycle consisted of a temperature cycle from −30 degrees Celsius to +45 degrees Celsius (95% relative humidity) and then to +85 degrees Celsius. The total time for each environmental cycle was twelve hours with the assembly being held at each temperature set point for about three hours.

The results showed the test load floor (the samples) only had an average permanent deflection of 4.7 mm under the 95 kg load, and no water penetrated into the paper honeycomb core layer.

Comparative test specimens missing the polyamide film layer exhibited a permanent deflection of 7.17 mm to 11.82 mm under the 95 kg load and experienced delamination of the thermoplastic layer from the paper honeycomb core layer indicating water penetration into the paper honeycomb core layer was likely.

These results were consistent with the use of the 70 gsm solid polyamide film providing a load floor that can resist delamination over a wide range of environmental conditions.

### Example 2

A test specimen was produced to determine if the test specimen could resist delamination after environmental cycling down to −40 degrees Celsius. Existing composite articles including bi-laminate skin layers and a thermoplastic porous core layer will typically delaminate once the temperature is lowered below −30 degrees Celsius.

The test specimens consisted of a scrim bonded to a first surface of a porous thermoplastic core (900 gsm including glass fibers and polypropylene). The test specimens also included and a bi-laminate skin bonded to a second surface of the porous thermoplastic core through a 80 gsm perforated film including a polypropylene (PP) layer, which is bonded to the porous thermoplastic core, and a copolyamide (CoPA) layer, which is bonded to the bi-laminate skin.

Each environmental cycle consisted of cycling between +23 degrees Celsius (about 50% relative humidity) to +85 degrees Celsius (>50% relative humidity) followed by a decrease of the temperature to −40 degrees Celsius. Each temperature set point was held for about three hours during the cycle.

Eight samples of the test specimen construct were exposed to the −40 degrees Celsius environmental cycling parameters with five total environmental cycles being used prior to testing. All eight test samples passed the environmental cycling without any delamination or blistering of the bi-laminate skin being observed.

Comparative examples including a similar core layer and bi-laminate skin were constructed, but the PP layer/CoPA layer film was replaced with a PP film. The comparative test specimens were each cycled five times over the same environmental conditions and in the same manner as the eight tested specimens including the PP layer/CoPA layer film.

Delamination of the bi-laminate skin from the porous thermoplastic core layer was observed in all comparative test specimens including the PP film. These results are consistent with the 80 gsm PP layer/CoPA layer film providing suitable adherence of a bi-laminate skin to a porous thermoplastic core over a temperature range of −40 degrees Celsius to +85 degrees Celsius.

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, examples and embodiments have been described above, it will be recognized by the person of ordinary skill in the art, given the benefit of this disclosure, that additions, substitutions, modifications, and alterations of the disclosed illustrative aspects, examples and embodiments are possible.

1. A composite article comprising:
a core layer;
a first skin; and
a first functional film disposed on a first surface of the core layer and between the core layer and the first skin, wherein the first functional film is effective to bond the first skin to the core layer after environmental cycling of the composite article over a temperature range of −40 degrees Celsius to +85 degrees Celsius without delamination of the first skin from the core layer.

2. The composite article of claim 1, wherein the first skin comprises a first porous layer comprising a web of open celled structures formed from reinforcing materials held in place by a thermoplastic material.

3. The composite article of claim 1, wherein the first functional film comprises at least two film layers.

4. The composite article of claim 3, wherein a first layer of the first functional film comprises a polyolefin layer and a second layer of the first adhesive film comprises a copolyamide layer, wherein the polyolefin layer is adjacent to the core layer and the copolyamide layer is adjacent to the first skin.

5. The composite article of claim 1, wherein the first functional film comprises a first polyolefin film layer and a second copolyamide film layer.

6. The composite article of claim 5, wherein the first polyolefin film layer comprises polypropylene.

7. The composite article of claim 6, wherein a basis weight of first functional film is at least 70 g/m².

8. The composite article of claim 1, wherein the first functional film comprises a polyamide film layer.

9. The composite article of claim 1, further comprising a second skin disposed on a second surface of the core layer.

10. The composite article of claim 9, further comprising a second functional film disposed between the second skin and the second surface of the core layer, wherein the second functional film is effective to bond the second skin to the core layer after environmental cycling of the composite article over a temperature range of −40 degrees Celsius to +85 degrees Celsius without delamination of the second skin from the core layer.

11. The composite article of claim 10, wherein the first skin comprises a first porous layer and the second skin comprises a second porous layer disposed on the second functional film, wherein the second porous layer comprises a web of open celled structures formed from reinforcing materials held in place by a thermoplastic material.

12. The composite article of claim 11, wherein the reinforcing materials in each of the first porous layer and the second porous layer comprises glass fibers.

13. The composite article of claim 12, wherein the thermoplastic material in each of the first porous layer and the second porous layer comprises a polyolefin.

14. The composite article of claim 13, wherein the polyolefin in each of the first porous layer and the second porous layer comprises polypropylene.

15. The composite article of claim 1, wherein the composite article is configured as vehicle load floor.

16. The composite article of claim 1, wherein the core layer comprises a paper honeycomb layer.

17. The composite article of claim 16, wherein the first functional film comprises:
(i) a film comprising a polyamide layer; or
(ii) a film comprising a copolyamide layer; or
(iii) a film comprising a polyolefin film layer and a copolyamide film layer; or
(iv) a film comprising a metallized film layer.

18. The composite article of claim 17, further comprising a second skin disposed on a second surface of the core layer and second functional film disposed between the second skin and the second surface of the core layer, wherein the second functional film is effective to bond the second skin to the core layer after environmental cycling of the composite article over a temperature range of −40 degrees Celsius to +85 degrees Celsius without delamination of the second skin from the core layer.

19. The composite article of claim 18, wherein a basis weight of each of the first functional film and the second functional film is at least 70 g/m².

20. The composite article of claim 19, wherein the first skin comprises a first porous layer and the second skin comprises a second porous layer, wherein each of the first porous layer and the second porous layer comprises a web of open celled structures formed from reinforcing materials held in place by a thermoplastic material.

21-50. (canceled)
